(19) United States
(12) Patent Application Publication
(10) Pub. No.: US 2024/0345600 A1
(43) Pub. Date: Oct. 17, 2024

(54) SELF-DRIVING SERVING ROBOT SYSTEM FOR SERVICE CALLS FOR MULTI-STORY BUILDINGS

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 18/402,308

(22) Filed: Jan. 2, 2024

(30) Foreign Application Priority Data
Apr. 17, 2023 (KR) 10-2023-0050289

(51) Int. Cl. G05D 1/667; B66B 1/34; B66B 1/46; G06Q 30/0601; G05D 105/20; G05D 107/40

(52) U.S. Cl. CPC G05D 1/667; B66B 1/3461; B66B 1/468; G06Q 30/0641; B66B 2201/4615; B66B 2201/4638; B66B 2201/4653; G05D 2105/20; G05D 2107/40

(57) ABSTRACT

The present invention relates to a self-driving serving robot system for service calls for multi-story buildings that improves the mobility of the self-driving service robot, expands its range of movement, and provides various services to customers.

### CROSS-REFERENCE TO RELATED APPLICATION

This application claims priority to and the benefit of Korean Patent Application No. 10-2023-0050289, filed on Apr. 17, 2023, the disclosure of which is incorporated herein by reference in its entirety.

### BACKGROUND

### 1. Field of the Invention

The present invention relates to a self-driving serving robot system for service calls for multi-story buildings, and more specifically, to a self-driving serving robot system for service calls for multi-story buildings that allows a serving robot to provide service to a customer in a general restaurant, a food court, a restaurant, a hotel, or the like in a multi-story building by being linked with a smart elevator system.

### 2. Discussion of Related Art

In recent years, restaurants and hotels have expanded in size and are often divided into multiple floors to accommodate more customers.

The traditional restaurant serving robots are limited in their ability to move between floors and provide service to customers in a timely manner.

As a result, a more efficient and convenient serving robot system that can smoothly provide service to customers on multiple floors of a restaurant or hotel is required.

Accordingly, the present invention is directed to providing a self-driving serving robot system for service calls for multi-story buildings that allows a serving robot to smoothly provide service to a customer located at any location (floor) in a multi-story building using an elevator.

### RELATED ART DOCUMENTS

### Patent Documents

(Patent Document 1) (Document 01) Korean Patent Registration No. 10-2322048 (registered on Oct. 29, 2021)

(Patent Document 2) (Document 02) Korean Laid-open Patent Publication No. 10-2022-0154112 (published on Nov. 21, 2022)

### SUMMARY OF THE INVENTION

The present invention is directed to providing a self-driving serving robot system for service calls for multi-story buildings that allows a self-driving serving robot to move to a customer and smoothly provide service to the customer located at any location (floor), such as a general restaurant, a food court, a restaurant, a hotel, or the like, in a multi-story building by being linked with a smart elevator system.

According to an aspect of the present invention, there is provided a self-driving serving robot system for service calls for multi-story buildings, which includes a self-driving serving robot configured to collect and deliver items from a supply point to a customer's location within a multi-story building, a smart elevator controlled through an application programming interface (API), and a robot server configured to process the customer order and assign a task to the appropriate self-driving serving robot, wherein the self-driving serving robot system allows the self-driving serving robot to move to any location within the multi-story building where the customer is located and provide service.

In this case, the self-driving serving robot may be configured to be linked with a smart elevator system using an API, call the smart elevator to a specific floor, identify a desired destination floor, and instruct the smart elevator to stop at the destination floor. The self-driving serving robot system for service calls for multi-story buildings may further include a customer terminal configured to allow a customer to view a menu, place an order, and receive an update on the order status, wherein, when the self-driving serving robot system includes the customer terminal, the robot server manages and coordinates communication between the self-driving serving robot and the customer terminal.

Meanwhile, prior to description of this specification, terms and words used in the appended claims should not be interpreted as being limited to commonly used meanings or meanings in dictionaries and should be interpreted with meanings and concepts which are consistent with the technological scope of the present invention based on the principle that the inventors have appropriately defined concepts of terms in order to describe the present invention in the best way.

Therefore, since embodiments described in this specification and configurations illustrated in the accompanying drawings are only exemplary embodiments and do not represent the overall technological scope of the present invention, it is understood that the present invention covers various equivalents, modifications, and substitutions at the time of filing of this application.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating an example of a self-driving serving robot system for service calls for multi-story buildings of the present invention; and

FIG. 2 is a flowchart illustrating a process of taking, processing, and delivering an order using the self-driving serving robot system for service calls for multi-story buildings of the present invention.

### DETAILED DESCRIPTION OF EXEMPLARY EMBODIMENTS

Hereinafter, the function, configuration, and operation of a self-driving serving robot system 1 for service calls for multi-story buildings of the present invention will be described in detail with reference to the accompanying drawings.

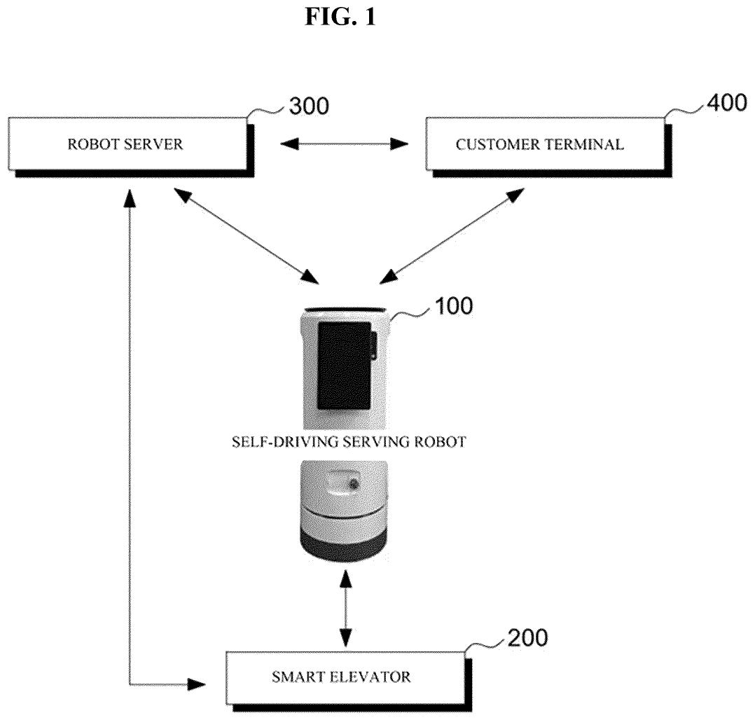

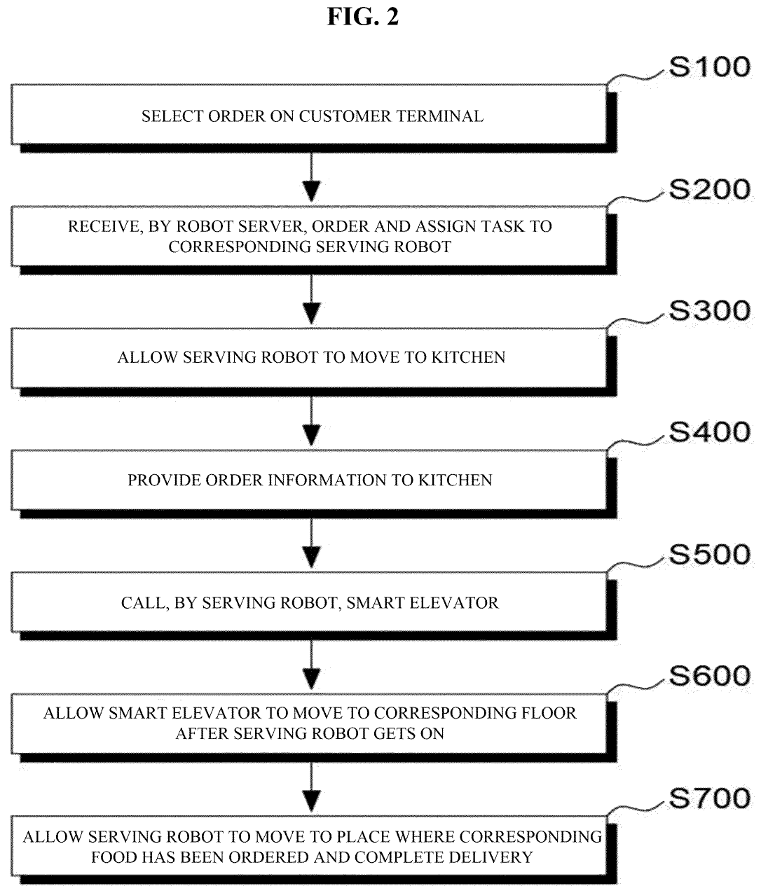

FIG. 1 is a schematic diagram illustrating an example of a self-driving serving robot system for service calls for multi-story buildings of the present invention, and FIG. 2 is a flowchart illustrating a process of taking, processing, and delivering orders using the self-driving serving robot system for service calls for multi-story buildings of the present invention.

As illustrated in FIGS. 1 and 2, the present invention provides a self-driving serving robot system 1 for service calls for multi-story buildings, which includes a self-driving serving robot 100 configured to collect and deliver items from a supply point to a customer's location within a multi-story building, a smart elevator 200 controlled through an application programming interface (API), and a robot server 300 configured to process a customer order and assign a task to the appropriate self-driving serving robot, wherein the self-driving serving robot system 1 allows the self-driving serving robot 100 to move to any location within the multi-story building where the customer is located and provide service.

Further, the self-driving serving robot 100 is configured to be linked with a smart elevator system using an API, call the smart elevator 200 to a specific floor, identify a desired destination floor, and instruct the smart elevator 200 to stop at the destination floor. The self-driving serving robot system 1 for service calls for multi-story buildings further includes a customer terminal 400 configured to allow a customer to view a menu, place an order, and receive an update on the order status, wherein, when the self-driving serving robot system 1 includes the customer terminal 400, the robot server 300 manages and coordinates communication between the self-driving serving robot 100 and the customer terminal 400.

As described above, the present invention relates to the self-driving serving robot system 1 for service calls for multi-story buildings that allows the self-driving serving robot 100 to move to any location (floor) where a customer is located and provide service to the customer using the smart elevator 200 even within a multi-story building, that is, allows the self-driving serving robot 100 to smoothly move to a called destination at any location (floor) within the multi-story building and provide various services to customers using the smart elevator 200.

More specifically, in the present invention, the self-driving serving robot system 1 for service calls for multi-story buildings includes a self-driving serving robot 100, a smart elevator 200, a robot server 300, and a customer terminal 400.

In the self-driving serving robot 100, a sensor 110 and an actuator 120 may be mounted to navigate autonomously and interact with the smart elevator system.

The smart elevator 200 includes an API that allows the self-driving serving robot 100 to communicate with the smart elevator system and control movements of the smart elevator system.

Through the API, the self-driving serving robot 100 may call the smart elevator 200, request the smart elevator 200 to stop at a specific floor, and move the smart elevator 200 between floors as necessary.

The robot server 300 receives a customer order from the customer terminal 400 and assigns a task to the appropriate self-driving serving robot 100.

On the customer terminal 400, the customer may view a menu and place an order, and the order is transmitted to the robot server 300 and processed.

That is, in operation, the customer places an order using the customer terminal 400, the robot server 300 assigns a task to the self-driving serving robot 100, which retrieves an ordered item from a supply point, and the self-driving serving robot 100 moves to a floor where the customer is located in cooperation with the smart elevator 200, and delivers the order to the customer's location.

The present invention may be applied to various types of multi-story facilities that require efficient and timely delivery of goods or services, including hotels, restaurants, hospitals, office buildings, etc.

In another embodiment, the self-driving serving robot 100 may further include a communication module 130 that enables direct communication with the customer in order to provide an update on the order status or receive additional instructions.

Further, the self-driving serving robot 100 may include a payment processing module 140, which simplifies the entire transaction process by allowing customers to complete payment for orders directly through the self-driving serving robot 100.

Further, the self-driving serving robot 100 may be designed to process multiple orders at one time, and thus efficiency may be increased and the need for multiple self-driving serving robots 100 in a single facility may be reduced.

Additionally, the smart elevator system may be configured to prioritize requests from the self-driving serving robot 100 to ensure timely delivery of orders and minimize smart elevator 200 waiting time.

As a result, the self-driving serving robot 100 that is linked with the smart elevator system may provide an efficient, convenient, and versatile solution for providing service to customers in a facility spanning multiple floors.

The present invention may significantly improve the overall customer experience while reducing labor costs and increasing facility operating efficiency.

That is, according to an embodiment of the present invention, a customer on a third floor of a hotel or restaurant views a menu and places an order through a customer terminal.

The order may include items such as a toothbrush set for hotel guests and entire pizzas for restaurant customers.

When receiving the customer order, the robot server assigns a task to the appropriate self-driving serving robot.

The self-driving serving robot moves to a supply point (kitchen or service area), displays the task, and retrieves an item or food ordered by the customer.

When the self-driving serving robot is on the first floor, the self-driving serving robot is linked with the smart elevator system, and requests the smart elevator to come to the first floor and stop at the third floor for customer service.

Thereafter, the self-driving serving robot moves to the customer's location and delivers the order.

The centralized robot server 300 may be linked with the self-driving serving robot 100, and may monitor and control the performance, location, and status of the self-driving serving robot 100 in real time.

Such a linkage may allow facility management to rapidly resolve any issues or make necessary adjustments to optimize the performance of the self-driving serving robot 100 and improve customer service.

In still another embodiment, the self-driving serving robot 100 may have advanced artificial intelligence feature, allowing it to learn from experience and improve its performance over time.

The advanced artificial intelligence feature may include optimizing navigation routes, improving customer demand predictions, and improving coordination with the smart elevator system.

The smart elevator system may incorporate additional features such as real-time occupancy monitoring and access control to ensure the safety and security of both the customers and the self-driving serving robot 100.

Further, the robot server 300 may be expanded to include other types of self-driving robots or automation systems to further enhance facility operations.

For example, an automated dishwashing or cleaning robot may be integrated into the robot server 300 to maintain cleanliness and hygiene standards within the facility.

In some embodiments, the robot server 300 may be designed to interact with other smart devices within the facility, such as smart lighting or climate control systems, to create a more comfortable and personalized environment for customers.

Further, the present invention has potential applications beyond restaurants and hotels.

For example, the present invention may be adapted for use in shopping malls, airports, or large commercial buildings where efficient and reliable delivery of goods or services is essential.

Overall, the self-driving serving robot 100 that is linked with the smart elevator system provides a versatile, efficient, and convenient solution for providing service to customers in a wide range of facilities with multiple floors.

By utilizing advanced techniques such as the self-driving serving robot 100 and the smart elevator 200, the present invention has the potential to revolutionize the way facilities operate and provide service to customers, and ultimately provide a more enjoyable and efficient customer experience.

The robot server 300 may be further improved by incorporating customer feedback mechanisms to collect valuable input about the performance and overall experience of the self-driving serving robot 100.

This feedback may be used to continuously improve the robot server 300 and consistently meet and exceed customer expectations.

In some embodiments, the self-driving serving robot 100 may be equipped with an additional sensor and camera to collect data for customer behavior and preferences.

By analyzing this data, it is possible to improve the performance of the self-driving serving robot 100, customize the customer experience, and tailor marketing efforts for the facility.

Further, the self-driving serving robot 100 may be designed with a modular structure so that components thereof can be easily upgraded or replaced as technology advances.

Due to such flexibility, the self-driving serving robot 100 may remain up-to-date and continue to provide efficient and high-quality service in the future.

In yet another embodiment, the robot server 300 may be integrated with a reservation or scheduling system to allow customers to request delivery at specific times or adjust other events or activities and orders within the facility.

The above feature may improve customer satisfaction by providing a more personalized and seamless experience.

Further, the self-driving serving robot 100 may be adapted to accommodate various types of facilities, such as facilities with unique architectural layouts or specific requirements.

In addition, the self-driving serving robot 100 may further improve its versatility and applicability by providing customization options to effectively meet the requirements of each facility.

That is, the self-driving serving robot 100 that can be linked with the smart elevator system to use the smart elevator 200 may have a significant impact on the service industry by providing an innovative and efficient solution for providing services to customers in multi-floor facilities.

Further, by utilizing advanced techniques and seamlessly incorporating the advanced techniques into the customer experience, the present invention may significantly improve customer satisfaction and revolutionize the way facilities operate.

The present invention includes several key components that operate together for the self-driving serving robot 100 that is linked with the smart elevator system to provide smooth and efficient service to customers in a multi-floor facility using the smart elevator 200.

These components include the following. Self-driving serving robot 100: The self-driving serving robot 100 may be equipped with various sensors, actuators, and an advanced navigation feature to autonomously move throughout the facility.

The self-driving serving robot 100 is designed to transport customer orders, such as food or other items, and deliver the customer orders to an appropriate location.

In some embodiments, the self-driving serving robot 100 may include a communication module for interacting with customers, a payment processing module for processing transactions, and an artificial intelligence function for improving performance over time.

Smart elevator 200: The smart elevator 200 is an important component of a system that allows the self-driving serving robot 100 to easily move between floors.

The smart elevator 200 is integrated with an API that allows the self-driving serving robot 100 to communicate with and control the smart elevator 200, and requests the smart elevator 200 to stop at a specific floor or call the smart elevator 200 as necessary.

Further, the smart elevator system may prioritize the request from the self-driving serving robot 100 and may incorporate safety and security features such as real-time occupancy monitoring and access control.

Robot server 300: The robot server 300 serves to receive a customer order from the customer terminal 400 and assign a task to the appropriate self-driving serving robot 100.

The robot server 300 manages the overall operation of the self-driving serving robot 100 and ensures that orders are processed efficiently and in a timely manner.

Customer terminal 400: Through the customer terminal 400, customers may view menus, place orders, and interact with the robot server 300.

In some embodiments, the customer terminal 400 may include a function that allows the customer to provide feedback on the performance of the self-driving serving robot 100 and their overall experience.

Central management system 500: In some embodiments, the robot server 300 may be integrated with a central management system 500 to monitor and control the performance, location, and status of the self-driving serving robot 100 in real time.

Such integration may help the facility management rapidly resolve any issues or make necessary adjustments to optimize the performance of the self-driving serving robot 100 and improve customer service.

These components operate together to generate an efficient and convenient solution for providing service to customers in multi-level facilities.

That is, by integrating the self-driving serving robot 100 with the smart elevator system, the present invention provides a new approach to solving problems associated with providing service to customers in large-scale multi-story facilities.

The related art regarding the operation of a self-driving serving robot related to the present invention has several limitations and problems, and the present invention solves the problems of the related art through the integration of the self-driving serving robot 100 and the smart elevator system.

The main problems of the related art compared to the present invention are as follows.

Limited navigation feature: Traditional restaurant serving robots often struggle to efficiently navigate and serve customers across multiple floors.

In order to move between floors, human intervention may be required, which may be time-consuming and negate the benefits of automation.

The present invention overcomes these problems by integrating the self-driving serving robot 100 with the smart elevator system to enable seamless navigation and service on multiple floors.

Since conventional serving robots cannot communicate effectively with other systems such as elevators, the process of receiving, processing, and delivering an order in the related art is less efficient and error prone.

In the present invention, the self-driving serving robot 100 and the smart elevator system solve this problem using an API, and thus the self-driving serving robot 100 may be linked with the smart elevator system and may optimize movement between floors to provide faster and more accurate service to customers.

Inadequate customer interaction: Traditional restaurant serving robots may lack a communication module to update a customer order or receive additional instructions and may therefore fail to provide a comprehensive customer experience.

The present invention may include a communication module, enabling direct communication with customers and more personalized service.

Difficulty in system monitoring and management: Servers that control conventional serving robots may not provide real-time monitoring and control functions, and thus it is difficult for the facility management to optimize the performance of the serving robots and immediately resolve problems.

The present invention is integrated with a centralized management system to enable real-time monitoring, control, and performance optimization of the serving robot.

Limited adaptability and customization: Traditional restaurant serving robots cannot be easily adapted to different types of facilities or specific requirements.

The present invention may provide a more versatile solution that can be customized to accommodate various types, layouts, and requirements of facilities while ensuring that the self-driving serving robot 100 effectively meets the needs of the customers of each facility.

By solving these limitations and problems of the related art, the present invention provides an innovative, efficient, and convenient solution for providing service to customers in multi-story facilities.

The integration of the self-driving serving robot 100 and the smart elevator system not only improves the overall customer experience, but also reduces labor costs and increases the facility's operational efficiency.

To summarize the present invention, the self-driving serving robot 100 that is linked with the smart elevator system is an innovative solution that is designed to solve the problem of providing service to customers in facilities with multiple floors, such as restaurants, hotels, hospitals, and office buildings.

The present invention includes several key components, including a self-driving serving robot 100, a smart elevator system, a robot server 300, and a customer terminal 400 that operate together to provide smooth and efficient service.

By integrating advanced techniques such as the self-driving serving robot 100 and the smart elevator 200, the present invention improves the overall customer experience, reduces labor costs, and improves the operational efficiency of the facility.

Further, the system provides adaptability, customization, and a real-time monitoring function to effectively meet different types of facility requirements and maintain high performance standards.

The API between the self-driving serving robot 100 and the smart elevator 200 plays an important role in enabling seamless communication and coordination between the self-driving serving robot 100 and the smart elevator 200.

The API provides a set of standardized protocols, functions, and data structures so that the self-driving serving robot 100 can efficiently and effectively interact with the smart elevator system.

Key functions of the API include the following.

Elevator call function: When this function is used, the self-driving serving robot 100 may transmit a request to the smart elevator 200 to allow the smart elevator 200 to arrive at a specific floor.

Upon receiving the request, the smart elevator 200 adjusts its operation to give priority to a call of the self-driving serving robot 100 and delivers an order in a timely manner.

Floor selection function: When this function is used, the self-driving serving robot 100 informs the smart elevator 200 of a desired destination floor so that the smart elevator 200 stops at an appropriate floor to pick up or unload the self-driving serving robot 100.

Elevator status provision function: This function provides real-time information about the current status of the smart elevator 200, such as a location, a direction, occupancy, and the like, to the self-driving serving robot 100.

The self-driving serving robot 100 may use this information to plan its movements more effectively and optimize its navigation.

Access control function: In some embodiments, the API may include an access control function for ensuring that only authorized self-driving serving robot 100 or staff members may operate the smart elevator 200 to enhance the security of the system.

The API between the self-driving serving robot 100 and the smart elevator 200 is operated through a series of data exchanges and commands.

When the self-driving serving robot 100 receives a customer order and needs to move to another floor, the self-driving serving robot 100 transmits a request to the smart elevator 200 using the elevator call function.

The smart elevator 200 processes the request and transmits a confirmation message indicating that the smart elevator 200 is in operation to the self-driving serving robot 100.

When the self-driving serving robot 100 arrives at the location of the smart elevator 200, information indicating that the smart elevator is ready to be boarded is transmitted to the self-driving serving robot 100.

Thereafter, the self-driving serving robot 100 gets on the smart elevator 200 and specifies a desired destination floor using the floor selection function.

The smart elevator 200 recognizes the destination floor and transports the self-driving serving robot 100 accordingly.

Throughout the process, the self-driving serving robot 100 and the smart elevator 200 exchange status information using the elevator status provision function so that the two components recognize each other's location and movement.

Through this continuous information exchange, optimal coordination between the self-driving serving robot 100 and the smart elevator 200 is possible, and thus efficient and timely order delivery is possible.

In summary, the API between the self-driving serving robot 100 and the smart elevator 200 is an important aspect of the present invention that enables seamless communication and coordination between the two components.

The API utilizes the standardized functions and data exchange to allow the self-driving serving robot 100 and the smart elevator 200 to operate effectively together and provide efficient and convenient service on multiple floors.

As an embodiment, in order to describe the ordering and delivery process performed through the self-driving serving robot system 1 for service calls for multi-story buildings of the present invention, a period of time from order to delivery is estimated in consideration of a scenario where a customer on the third floor orders spaghetti through the customer terminal 400.

Customer order T0: A customer selects spaghetti, puts the spaghetti in a shopping cart, and then clicks “Order” on the customer terminal 400.

Order processing T1: The robot server 300 receives the order and assigns a task to the self-driving serving robot 100 located on the first floor.

It takes 10 seconds for the robot server 300 to process the order and assign the task.

Self-driving serving robot 100 moves to kitchen T2: The self-driving serving robot 100 moves to the kitchen to pick up the spaghetti.

Assuming that the self-driving serving robot 100 moves at a speed of 1 m/s and the kitchen is 20 m away from a starting point of the self-driving serving robot 100, the time it takes for the self-driving serving robot 100 to reach the kitchen is as follows.

$$T 2 = distance / speed = 20 m / 1 m / s = 20 seconds$$

Spaghetti preparation T3: The self-driving serving robot 100 informs a kitchen staff member of the task and the staff member serves the spaghetti.

It is assumed that it takes five minutes (300 seconds) to make spaghetti.

Robot call elevator T4: The self-driving serving robot 100 calls the smart elevator 200 to the first floor.

It is assumed that it takes 10 seconds for the smart elevator 200 to arrive.

Self-driving serving robot 100 and smart elevator 200 move to third floor T5: The self-driving serving robot 100 gets on the smart elevator 200 and moves to the third floor together.

Assuming that the smart elevator 200 moves at a speed of 0.5 m/s and a height between floors is 6 m, the time it takes for the smart elevator 200 to reach the third floor is as follows.

$$T 5 = ( height * number of floors ) / speed = ( 6 m * 2 ) / 0.5 m / s = 24 seconds$$

Self-driving serving robot 100 delivers spaghetti T6: The self-driving serving robot 100 visits the customer and delivers the spaghetti.

It is assumed that the customer is located 15 m away from the smart elevator 200 on the third floor and it takes 15 seconds for the self-driving serving robot 100 to complete the delivery.

The total time from order to delivery is as follows.

$$Total time = T 1 + T 2 + T 3 + T 4 + T 5 + T 6 = 10 seconds + 20 seconds + 300 seconds + 10 seconds + 24 seconds + 15 seconds = 379 seconds .$$

Therefore, in this scenario, it takes about 379 seconds (or about 6 minutes and 19 seconds) for the self-driving serving robot 100 to deliver the spaghetti from the time the customer places an order.

In the above time-consuming scenario, based on the present invention, the time from order to delivery was estimated for the scenario where a customer on the third floor orders spaghetti through the customer terminal 400.

Now, the same scenario and conditions are considered, and it is assumed that the ordering and delivery process is handled by a human waiter.

In addition, potential human errors that may occur during the process are also reviewed.

Customer order T0: A customer selects spaghetti, puts the spaghetti in a shopping cart, and then clicks “Order” on the customer terminal 400.

Order processing T1: A wait staff member takes an order through a terminal at a service counter.

It is assumed that it takes 15 seconds for the staff member to process the order and deliver the order to the kitchen.

Spaghetti preparation T2: A kitchen staff member prepares spaghetti.

It is assumed that it takes five minutes (300 seconds) to prepare the dish.

Waiter moves to kitchen T3: The waiter moves to the kitchen to pick up the spaghetti.

It is assumed that the waiter moves at a speed of 1 m/s and the kitchen is 20 m away from the service counter.

The time it takes for the waiter to arrive at the kitchen is as follows.

$$T 3 = distance / speed = 20 m / 1 m / s = 20 seconds$$

Waiter calls elevator T4: The waiter calls the elevator to the first floor.

It is assumed that it takes 15 seconds for the elevator to arrive.

Waiter and elevator move to third floor T5: The waiter gets on the elevator and moves to the third floor together.

Assuming that the elevator moves at a speed of 0.5 m/s and a height between floors is 6 m, the time it takes for the elevator to reach the third floor is as follows.

$$T 5 = ( height * number of floors ) / speed = ( 6 m * 2 ) / 0.5 m / s = 24 seconds$$

Waiter delivers spaghetti T6: The waiter moves to the customer's location and delivers the spaghetti.

It is assumed that the customer is located 15 m away from the elevator on the third floor and it takes 15 seconds for the waiter to complete the delivery.

The total time from order to delivery is as follows.

$$Total time = T 1 + T 2 + T 3 + T 4 + T 5 + T 6 = 10 seconds + 300 seconds + 20 seconds + 15 seconds + 24 seconds + 15 seconds = 389 seconds .$$

In this scenario, it takes about 389 seconds (or about 6 minutes and 29 seconds) for the human waiter to deliver the spaghetti from the time the customer places an order.

A difference between the time it takes the human waiter to deliver the spaghetti and the time it takes the self-driving serving robot 100 to deliver the spaghetti is about 10 seconds, and the self-driving serving robot 100 is slightly faster.

However, errors that humans can make during this process are as follows.
1) Miscommunication: The waiter may misunderstand or misrecognize an order and the wrong dish may be prepared or delivered.
2) Delays in order processing: The waiter may become distracted or preoccupied with other tasks, resulting in delays in processing or delivering orders to the kitchen.
3) Spilling or damaging food: When the waiter may accidentally spill or damage food while transporting plates, the waiter should prepare a new plate.
4) Wrong delivery location: The waiter may deliver the plates to the wrong table or floor, causing confusion and delaying delivery to the correct customer.

By using the self-driving serving robot system of the present invention, these potential human errors may be minimized, and thus a more efficient and stable ordering and delivery process may be ensured.

The following is a simple example of programming in Python in which, in order to facilitate seamless communication between the self-driving serving robot 100 and the smart elevator 200 using an API, the self-driving serving robot 100 checks a real-time status of the smart elevator 200, checks whether the smart elevator 200 is valid, then calls the smart elevator 200 to the first floor, and allows the smart elevator 200 to stop at the third floor.

```
  import requests
  # Fetch real-time status of smart elevator 200 in API
  def get_elevator_status(elevator_id):
    response =
requests.get(f’https://api.example.com/elevators/{elevator_id}/status’)
    return response.json( )
  # Call smart elevator 200 to specific floor
  def call_elevator(elevator_id, floor):
    response = requests.post(f’https://api.example.com/elevators/{elevator_id}/call’,
json={“floor”: floor})
    return response.json( )
  # Set destination floor of smart elevator 200
  def set_destination_floor(elevator_id, floor):
    response =
requests.post(f’https://api.example.com/elevators/{elevator_id}/destination’, json={“floor”:
floor})
    return response.json( )
  # Main function
  def main( ):
    elevator_id = 1
    current_floor = 1
    destination_floor = 3
    # Check real-time status of smart elevator 200
    elevator_status = get_elevator_status(elevator_id)
    # Check whether smart elevator 200 is valid
    if elevator_status[‘is_valid’]:
      print(“Valid elevator found”)
      # Call smart elevator 200 to current floor (first floor)
      call_result = call_elevator(elevator_id, current_floor)
      if call_result[‘success’]:
        print(f“Elevator {elevator_id} called to the first floor”)
        # Set destination floor (third floor) of smart elevator 200
        destination_result = set_destination_floor(elevator_id,
destination_floor)
        if destination_result[‘success’]:
          print(f“Elevator {elevator_id} programmed to stop on the third
floor”)
        else:
          print(“Error setting elevator destination floor”)
      else:
        print(“Error calling the elevator”)
    else:
      print(“No valid elevator found”)
  if_{——}name_{——} == “_{——}main_{——}”:
    main( )
```

In the above example, a virtual API is used in addition to an end point in order to fetch real-time status information of the smart elevator 200, call the smart elevator 200 to a specific floor, and set a destination floor.

The Python program first checks the real-time status of the smart elevator 200 and determines whether the smart elevator 200 is valid.

When it is determined that the smart elevator 200 is valid, the self-driving serving robot 100 calls the smart elevator 200 to the first floor and then sets the third floor as a destination floor.

Steps of the above Python program are as follows.

The Python program provided in the previous response includes several steps to facilitate communication between the self-driving serving robot 100 and the smart elevator 200 using an API.

The following is an analysis of each step.
1) Step of defining a helper function

get_elevator_status(elevator_id): This function transmits a GET request to the API to retrieve the status of a specific smart elevator 200 identified by an ID.

This function returns the status of the specific smart elevator 200 as a JavaScript Object Notation (JSON) entity.

call_elevator(elevator_id, floor): This function transmits a POST request to the API to request the smart elevator 200 to be called to a specific floor.

This function returns a result of the request as a JSON entity.

set_destination_floor(elevator_id, floor): This function transmits a POST request to the API to set a destination floor of the designated smart elevator 200.

This function returns a result of the request as a JSON entity.
2) Step of defining a main function: This function includes the main logic of the program.

The following steps are performed.
a. Variables for the ID of the smart elevator 200, the current floor (first floor), and the arrival floor (third floor) are defined.
b. The “get_elevator_status (elevator_id)” function is used for checking the status of the designated smart elevator 200.
c. Whether the smart elevator 200 is valid is checked by determining the real-time status of the smart elevator 200 and the field “is_valid” of the JSON entity.

When it is determined that the smart elevator 200 is valid, the process proceeds to the next step.

Otherwise, an error message is output.
d. The smart elevator 200 is called to the current floor using the “call_elevator (elevator_id, current_floor)” function.

When the call is successful, the process proceeds to the next step.

Otherwise, an error message is output.
e. The destination floor of the smart elevator 200 is set using the “set_destination_floor (elevator_id, destination_floor)” function.

When the destination floor is set successfully, a confirmation message is output.

Otherwise, an error message is output.
3) Step of executing the main function: An “if_name_==”_main_“:” block at an end of the script ensures that a “main( )” function is executed when the script is executed directly.

As described above in the above configuration and operation, according to the present invention, it is possible to maximize the degree of freedom (serving activity range) of a self-driving serving robot for multi-story buildings.

That is, by allowing a self-driving serving robot to smoothly move to any location (floor) in a multi-story building and provide service to a customer located at any location (floor) by being linked with the smart elevator system, it is possible to maximize the utility of the self-driving serving robot by expanding a movement range of the self-driving serving robot.

As described above, the present invention is not limited to the embodiments described above, and it should be clear to those skilled in the art that various changes and modifications thereto are possible without departing from the spirit and scope of the present invention.

Therefore, the present invention may be implemented in various other forms without departing from the technical idea or main features, and thus the embodiments of the present invention are merely examples in all respects and should not be construed as limited, and may be implemented with various modifications.

### INDUSTRIAL APPLICABILITY

The present invention relates to a self-driving serving robot system for service calls for multi-story buildings, and can be applied to contribute to the advancement of the software development industry for self-driving service robots that improve the mobility of the self-driving service robot, expand its range of movement, and provide various services to customers located at any location (floor) within a multi-story building by being linked with a smart elevator system, even in not only the overall optimization industry of service robots related to robot hardware and software and program execution that are developed and manufactured primarily for service purposes, but especially within multi-story buildings.

What is claimed is:

1. A self-driving serving robot system (1) for service calls for multi-story buildings, comprising:
a self-driving serving robot (100) configured to collect and deliver items from a supply point to a customer's location within a multi-story building;
a smart elevator (200) controlled through an application programming interface (API); and
a robot server (300) configured to process the customer order and assign a task to the appropriate self-driving serving robot,
wherein the self-driving serving robot system (1) allows the self-driving serving robot (100) to move to any location within the multi-story building where the customer is located and provide service.

2. The self-driving serving robot system of claim 1, wherein the self-driving serving robot (100) is configured to be linked with a smart elevator system using an API,
call the smart elevator (200) to a specific floor,
identify a desired destination floor, and
instruct the smart elevator (200) to stop at the destination floor.

3. The self-driving serving robot system of claim 1, further comprising a customer terminal (400) configured to allow a customer to view a menu, place an order, and receive an update on the order status,
wherein, when the self-driving serving robot system (1) includes the customer terminal (400), the robot server (300) manages and coordinates communication between the self-driving serving robot (100) and the customer terminal (400).
